(19) United States
(12) Patent Application Publication
(10) Pub. No.: US 2002/0128952 A1
(43) Pub. Date: Sep. 12, 2002

(54) Virtual interactive global exchange

(76) Inventors: Raymond Melkomian, Douglaston, NY (US); Sanjay Sarma, Belmont, MA (US)

Correspondence Address: William J. Sapone, Esq., The offices of Coleman Sudol Sapone P.C., 714 Colorado Ave., Bridgeport, CT, 06605, US

(21) Appl. No.: 09/900,476

(22) Filed: Jul. 6, 2001

Related U.S. Application Data
(60) Provisional application No. 60/216,195, filed on Jul. 6, 2000.

(51) Int. Cl. G06F 17/60

(52) U.S. Cl. 705/37

(57) ABSTRACT

A computer based virtual reality trading system for trading financial products such as commodities and stocks uses a server based system for generating a virtual trading floor to simulate an exchange. Traders use local PC's to direct their individual avatars interactively on the virtual trading floor, using hand and voice signals similar to a non-virtual exchange. This allows an exchange to be de-coupled from its physical geographic location as traders in diverse locations can interact on the virtual trading floor. The system enables accurate tracking for audit of the trade activity and simplified trade clearing, while retaining the dynamics of a non-virtual exchange.

### CROSS REFERENCE TO RELATED APPLICATIONS

This application claims priority in U.S. Provisional patent application No. 60/216,195 filed Jul. 6, 2000.

### TECHNICAL FIELD

This invention relates to an exchange for various securities and commodities that simulates in a virtual environment an active trading floor.

### BACKGROUND

Various systems exist which allow people to buy and sell securities such as stocks, futures, options, commodities, etc. Examples would include The New York Stock Exchange, The National Association of Security Dealers Automated Quotation, The American Stock Exchange, The Chicago Mercantile Exchange, among others.

The most common method for trading such securities is the Open Out Cry Auction.

Conducted in trading pits—designated areas on the trading floor of the exchange—this often hectic and dramatic auction places the traders of a particular contract face-to-face, allowing any trader to make an offer “by open outcry” to buy or sell an announced number of contracts at an announced price.

A trading pit-or ring, as it is sometimes called, is generally a polygonal or circular platform with one or more concentric rings of steps dropping toward the center; hence “pit.” One pit is often dedicated to the exchange of a certain contract type (that is, a particular commodity or financial instrument), and the traders of a given delivery date for that contract type are sometimes informally grouped in a corresponding area of the pit. The nearby contract, that is, the contract with the earliest delivery date, is often the most actively traded, and is therefore often traded on the topmost step of the pit, as close as possible to the phone desks of the futures commission merchants. In other cases, the pit is divided as a pie is divided into slices, with the trading in different delivery dates located in corresponding “slices” of the pit. For purposes of ticker and wallboard display, bidding information is collected by exchange employees in a pulpit, also known as a rostrum, usually located on the fringe of the pit.

By regulation, a trader announcing a bid (proposal to buy) or offer (proposal to sell) must do so both vocally (calling out the price and number of contracts) and by hand signals, though these regulations are not always precisely followed. The price quoted for a given contract type is generally given in terms of a convenient unit size, such as bushels for grains, ounces for gold, or barrels for oil, even though one contract may represent multiple units (for example, 5,000 bushels of corn or 1,000 barrels of crude oil). A typical convention for vocalizing an offer is number of contracts at a price, for example “three at thirty,” for a proposal to sell a number of contracts at a unit price. The corresponding convention for vocalizing a bid is a price for the number of contracts, meaning a proposal to buy a number of contracts at a unit price. Because of the usually high noise level, the order of calling price and quantity is reversed in this way between bids and offers in order to reduce confusion. For brevity and speed, only the fractional part of the price is usually called out, since the price generally moves through whole number levels gradually enough to preclude ambiguity. The minimum fractional price fluctuation for grains is often a quarter of a cent per bushel and for crude oil is one cent a barrel. Bids and offers are also given by hand signals. The following conventions are used at the Chicago Mercantile Exchange:

1. An offer is indicated by facing the palm of the hand outward, away from the proposer; a bid is signaled by facing the palm of the hand inward, toward the proposer.

2. Price quotes are given with the hand directly in the front of the trader's body. Prices are in terms of the number of ticks above the current whole number of the price. Volume signals are made with the hand away to one side of the body; the number signaled refers to the number of contracts.

3. The numbers 0 through 5 are indicated by the number of fingers shown pointing upward. The numbers 6 through 9 are shown as 5 plus the number of fingers pointing horizontally.

Bids and offers must be made openly in this fashion for the benefit of all traders in the pit; trade must occur with the first trader to signal acceptance. If two or more traders simultaneously accept a bid or offer, the trade (if more than a single contract) must be shared among them. Traders must be silent if they are not prepared to bid or offer at prices comparable to or better than the best current prices (the highest bid or lowest offer).

At the culmination of a trade, the trader on each side records the number of contracts, the contract type, the delivery date (by the symbol for the delivery month), the price, the name of the clearing firm of the member on the opposite side of the trade, and the initials of the trader on the opposite side. Traders may wear color-coded clothing or letter-coded badges in order to identify their status and firm, according to the convention of the exchange. On some exchanges, each half hour of the trading period is assigned a different letter of the alphabet, which is prominently displayed on the trading floor. This letter signal, the time bracket, would then also be recorded with each trade. All orders received from outside the exchange must also be time-stamped as they reach the order desk of the FCM handling the order; this is a CFTC regulation. If made on the personal account of the trader, the trade is recorded on a trading card illustrating the buyer's badge number, the trade date, contract code, contract month, number of contracts, seller's badge, price and if necessary the time bracket. If the trade is executed for a customer, the information is recorded on a multipart order ticket illustrating the name of the firm, whether it's a buy or sell, quantity, commodity, contract month, execution order type whether it's limit or market, account number of the customer, and the execution price. Each trade is recorded twice, once by each side; any discrepancies, or out trades, are handled with the clearing procedure.

On some exchanges, trades in the least active contracts occur by board trading, that is, by posting bids or offers on boards outside the pits. The contract type, delivery date, quantity, and price are posted under “BUY” or “SELL,” and remain posted until canceled or matched by another bid or offer, at which time a contract is constituted and recorded by an exchange employee on a sales board, along with the identities of buyer and seller. Bids and offers must first be made in the pits by open outcry, for all to hear and observe, before being transferred to a trading board. Electronic systems replaced the open outcry bids and offers and transferred the board activity to a screen based trading system.

Another form of auction, not as vigorously used in the U.S. exchanges, is electronic trading. With this form of auction, bids and offers are made electronically by traders, perhaps physically removed from one another, and matched by computer, in the manner of board trading.

The International Futures Exchange, INTEX, is an electronic futures exchange operated as a Bermuda corporation, with trading from computer terminals located throughout the world, including several U.S. locations. Clearing for INTEX is done by the International Commodities Clearing House Limited (ICCH) the common clearinghouse of British future markets. The Chicago Mercantile Exchange and Chicago Board of trade introduced an electronic trading system called Globex (previously known as Post-Market-Trading) for executing trades after normal trading hours at the International Monetary Market. There is also the Tokyo Stock Exchange electronic trading system called TOPIX. The New York Mercantile Exchange has its own electronic trading system called NYMEX ACCESS.

The advent of electronic trading promises efficiencies in clearing and back office operations, access to markets by physically distant traders. The fairness of order execution has been the topic of discussion since the inception of screen trading. The market participants who have used electronic trading systems have argued that there have been misrepresentations of price and liquidity on the electronic trading systems.

Since electronic trading will be based on a different type of auction than the traditional open outcry format, there is no guarantee that it can improve the overall efficiency of the markets. There may also be some resistance to the introduction of electronic trading by exchange members who have a vested interest in the current market system. After all, if electronic trading systems replaced the exchange floors and the open outcry auction method, the locals from the exchange floors would eventually lose their jobs and livelihood.

Another recent comer to the electronic trading markets is EUREX. It is the first pan-European exchange. Its screen-based trading system makes EUREX the first completely computerized exchange in Europe. Today, EUREX's market participants have access to the electronic trading platform from 14 European countries and the United States.

MATIF SA, the French futures and options Exchange, acts in a dual capacity as market operator and clearinghouse. MATIF SA is a wholly owned subsidiary of the French stock exchange, the SBF-Paris Bourse since December 1997. In the second quarter of 1998, trading switched from open outcry to electronic for all MATIF futures contracts. NSC is MATIF's electronic trading system (Nouveau Systeme de Cotation), which has been developed and is used by the SBF-Paris Bourse. It has been adopted as well by MONEP, the French equity derivatives exchange. NSC tends to become a standard with its adoption by the Chicago Mercantile Exchange (under the name Globex2), as by more than ten other stock exchanges or derivatives markets so far.

LIFFE has implemented a program that is anchored by the development of LIFFE CONNECT™, an electronic trading system that will provide users with a powerful combination of high performance capacity and an open system design.

Sydney Futures Exchange is an Asian financial futures and options exchanges with annual turnovers in 1999 of over 29.7 million contracts. All trading on SFE is conducted on its electronic trading system, SYCOM®. SYCOM®R terminals are available not only in Australia but also in other major financial centers such as London, Hong Kong and Japan. Future trading hubs are also planned for both New York and Chicago. The Sydney Futures Exchange Clearing Hose (SFECH) provides clearing services for SFE and its wholly owned subsidiary the New Zealand Futures & Options Exchange.

On Nov. 11, 1999, the New York Mercantile Exchange introduced its updated version of NYMEX ACCESS®. NYMEX ACCESS® is an acronym for the New York Mercantile Exchange American Computerized Commodity Exchange System and Services and is a computerized order matching system that enables certified users to trade certain NYMEX and COMEX Division futures, options, and spreads outside of regular trading hours. The updated version of NYMEX ACCESS® was designed for Year 2000 compliance. The table (2) below displays the most active electronic trading systems.

| | Exchange | Country |
|---|---|---|
| INTEX | International Futures Exchange | Bermuda |
| GLOBEX | Chicago Mercantile Exchange | U.S. |
| ACCESS ® | New York Mercantile Exchange | U.S. |
| EUREX | Pan-European Exchange | Europe |
| SYCOM | Sydney Futures Exchange | Australia |
| CONNECT | London International Financial | Great Britain |
| | Futures Exchange | |
| NSC | MATIF | France |
| TOPIX | Tokyo Stock Exchange | Japan |

The existing systems have three major components that occur on the floor of the exchange: trade execution, back office activity and trade reporting. These are illustrated with reference to FIGS. 1, 2 and 3.

With reference to FIG. 1, this shows the sequence for trade execution. All of these steps take time and numerous people so that the process can take from five minutes to about two hours.

With reference to FIG. 2, the back office activity is shown. Here, a screen clerk picks up all executed trade sheets from the ring broker every 15 minutes, though during heavy activity, this process can take as long as 2 hours. When there is high activity, the screen clerks may have to stand in line to enter executed trades into the exchange terminals, and because of the high volume, errors can occur when entering the trades in the system. These errors can include entering buy instead of sell, entering the wrong contract size, price or broker code. A screen clerk may have to enter 200 trades in 15 minutes.

With reference to FIG. 3, the trade reporting process is shown. The trade reporting process is very involved. Entries are checked for accuracy and reports sent to the clearing firms of the clients using the clearing firm code and the client account number. Each clearing firm has an exchange code added to the client account number. When the screen clerk enters the trades, he includes as well the account number of the client and the ring broker code. Errors are inevitable and if there are discrepancies, the exchange compliance department must research the activities of the ring broker. This is a slow process as it involves a small staff managing up to 900 floor traders.

Existing commodities and stock markets are limited to their immediate time zones and geographic areas. The market makers, traders and brokers come from the local area and the lesser the market participants, the more limited is the liquidity of the market. The existing exchanges are also limited by physical space. New markets cannot be added without expanding floor space, and the size of a trading ring is also limited as only so many people can gather in a pit for effective trading. Commodity exchanges have not been able to provide the benefits of hedging to all market participants in different parts of the world. Thus, a commodity might be listed at several exchanges situated in different time zones, leading to unnecessary arbitrage and inconsistencies in pricing and trading. There are also limitations in the audit trail, and in brokering swaps, as a swap broker may trade ahead of the client, or reveal the clients' position, size or name and compromise anonymity.

Various computer based systems for electronic trading have been proposed and are found in the patent literature, such as in U.S. Pat. Nos. 4,412,287, 4,677,552 and 6,014,643, among others. However, present electronic trading and the various patents do not have the capability to acceptably simulate the open outcry that occurs on a trading floor, and continue to suffer from the problems identified above. For example, the electronic trading systems have difficulty showing the market depth and breadth, as a computer monitor can display only a limited amount of information, in a two-dimensional environment. Such electronic trading systems loose the exchange market makers, who are specialists who perform a function of coming between a buyer and a seller, able to initiate a trade at different times.

### SUMMARY OF THE INVENTION

It is an object of the present invention to provide a computer based system for creating a virtual environment that simulates a trading floor.

It is a further object to provide a computer based system that enables users to electronically use an open outcry auction for trading securities.

It is yet another object to allow multiple users to participate on a virtual trading floor environment utilizing the open outcry method, as a direct substitute for an actual trading floor.

These and other objects of the present invention are achieved by a computer system comprising:

means for creating a virtual environment simulating a trading floor;

means for providing multiuser registration for accessing the trading floor;

means for establishing an iconic representation for each registered user;

means for supporting direct interaction between the iconic representation to effect trading interactions; and

means for recording and storing the trading interactions.

Utilizing the present invention, a user enters the virtual trading pit and participates in trading using an open outcry auction system. All of the features and nuances that are unique to the face to face interaction on a trading floor are acceptably incorporated and integral to the virtual trading environment. Such a system makes geographic boundaries transparent by nature, as the virtual exchange floor is available to all market makers, traders, brokers, etc, from any location in the world. Without physical limitations, there is unlimited floor space available, and pits can be added or expanded at will, allowing more liquidity in existing markets and less expense in launching new markets.

Preferably, the system utilizes a computer system with high speed processing capability having programming for providing a real time environment for participants, whether located locally or remotely, as well as for maintaining security and for recording and storing orders to insure the integrity of the process.

A user would access the environment via a computer terminal preferably including voice recognition software so that verbal statements are repeated in the virtual environment. Physical manipulation, such as the hand signals commonly used can be displayed based on user input via keyboard, mouse, voice, joystick or preferably by virtual input from a virtual device such as a glove that converts hand movement into a digital signal for simulation on the virtual trading floor. Various devices are known for user interaction with a virtual environment, from a glove, to a headset with an internal or heads up display to a full body dome environment.

Remote inputs from multiple users are processed to assure coordinated response on a common virtual time scale, to eliminate transmission delays which might otherwise favor local users. Similarly, the user when in the virtual environment is capable of responding or interacting with others on the virtual floor, through a display that may be a screen or heads-up display or via another sensory simulating device so as to simulate face to face interaction without external distraction.

The purpose of the inventive exchange is to facilitate trades, to transact or conduct an increased amount of business. An exchange facilitating human behavior, which is dynamic, evolving and ever changing, creates market behavior. Markets are merely humans reacting or not reacting to information and opportunities. The inventive electronic open outcry system provides the ideology of floor trading electronically.

The virtual exchanges perform three functions: (1) provide and maintain a physical marketplace (often called the floor) electronically in a virtual reality where securities can be bought and sold by the trading community or members of the exchange; (2) police and enforce ethical and financial standards applicable to the trading conducted on the exchange electronically in real-time using an electronic operations center; and (3) promote the business interests of the trading community (members). The virtual exchanges do not themselves engage in trading securities, but only provide the facilities or platform for others to do so.

Preferably, each virtual exchange will correspond to a real exchange in structure and be a for-profit organization that will have shareholders of common and preferred stocks, with persons being able to buy a seat on a virtual exchange so as; (1) to engage in floor trading activities; (2) to acquire the right to execute trades without having to pay commissions; and (3) on monthly basis to collect interest (rent, lease, or stock dividend) on the current value of the seat or equity owned. Generally, the value of the equity (seat) rises as the trading volume and open interest on an exchange increases.

The invention provides an electronic trading platform particularly for all manner of financial products such as traded on the securities, commodity futures and options markets, allowing members and market participants to hedge, speculate, and broker for example in various futures and option contracts in an open outcry methodology. As the exchange virtually simulates an environment resembling the floor of a commodity exchange, the traders will congregate in a virtual trading pit to announce their bids and offers. This system provides price discovery and market participant anonymity.

The virtual system can optionally provide services to existing domestic and international exchanges for them to trade during their off hours and to take advantage of the automated audit trail.

### BRIEF DESCRIPTION OF THE DRAWINGS

FIG. 1 is an illustration of trade activity.

FIG. 2 is an illustration of back room activity.

FIG. 3 is an illustration of trade reporting.

FIG. 4 is a view of a virtual exchange floor; FIG. 4a is another view thereof.

FIG. 5 is an illustration of the inventive virtual exchange system.

FIG. 6 is an illustrative view of the interchange on the inventive virtual exchange system.

FIG. 7 is an illustrative view of the virtual exchange organization.

FIG. 8a is an illustrative view of a virtual trade floor as configured for use by a trader, FIG. 8b is an enlarged view of a “hot zone” (an area of heavy trading), and FIG. 8c is a view of the exchange with multiple trading pits..

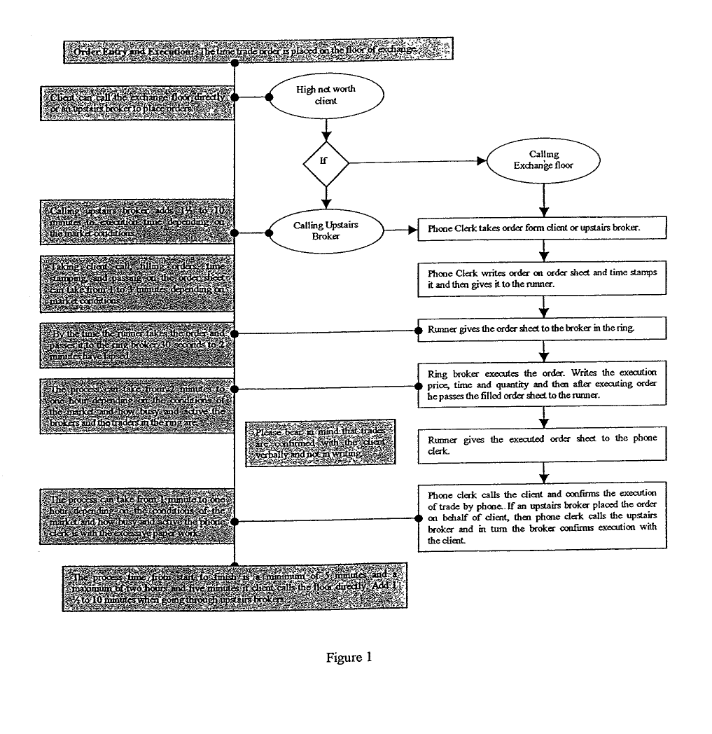

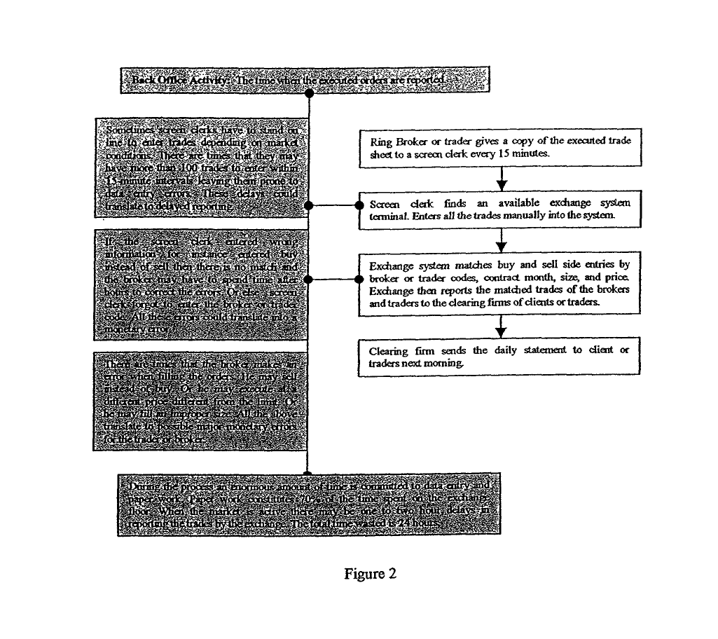

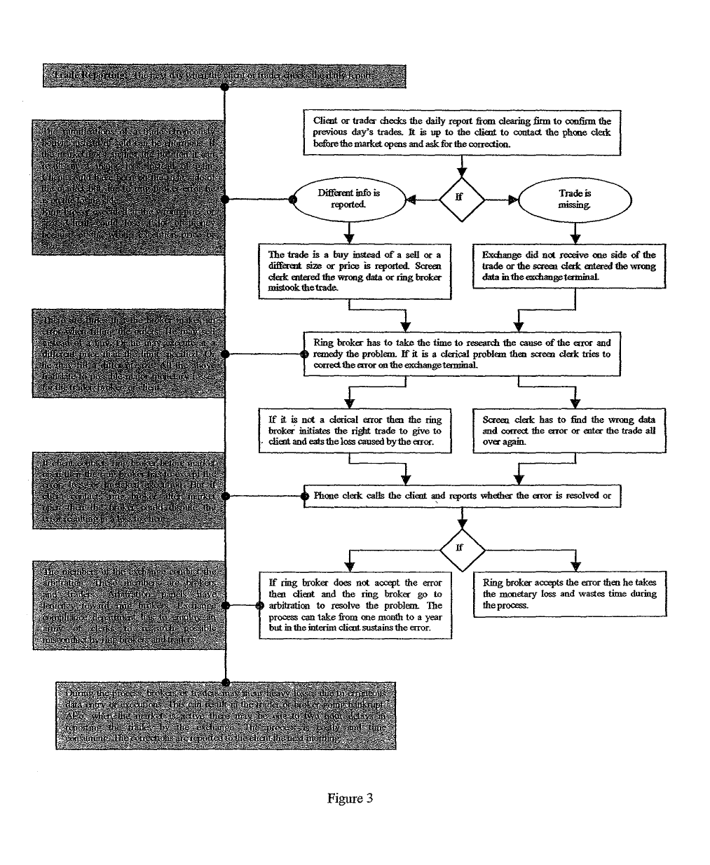

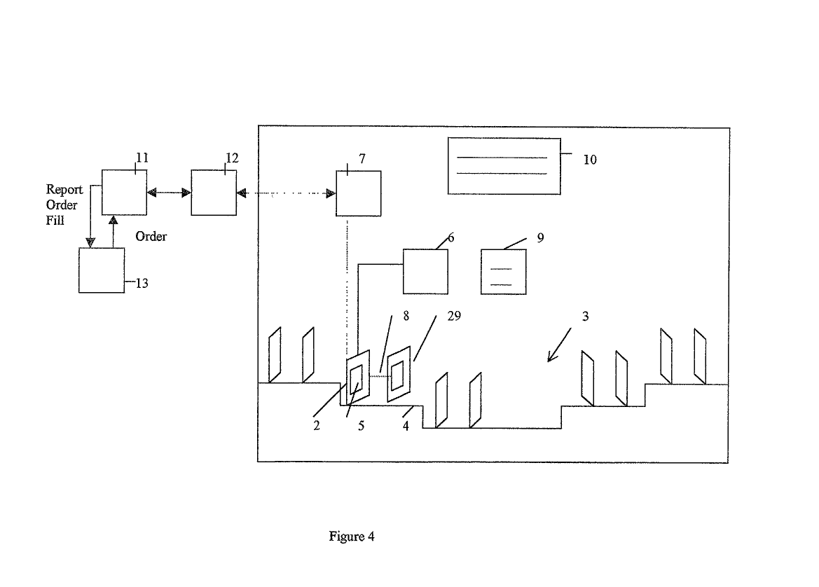

### DETAILED DESCRIPTION OF THE INVENTION

Virtual reality is a three dimensional computer-generated interface that allows users to see, move through and interact with information displayed as a three dimensional world. The three dimensional world is called a virtual reality world or cyberspace. For example, a virtual reality world could be the inside of a building or a golf course. The virtual reality world is displayed using sophisticated output devices, such as high resolution color screens or a headset with a monitor in front of each eye to give the user the illusion that he or she is situated in the virtual reality world.

The virtual reality world can display real world objects. For example, a chair could be displayed in a virtual reality world, representing a chair in the real world and appearing to have all the physical properties of a real world chair. In such a virtual reality world, the user views and interacts with the display as if the user was in the real world.

The virtual reality world is usually generated using a high speed computer processor and specialized graphics hardware. The computer processor and graphics hardware can be controlled by a program, called a virtual reality generator to create and continuously modify a virtual reality world and to simulate movement through the virtual reality world.

Virtual reality is regarded as having three features, namely immersion, navigation and interaction. Immersion is the use of sophisticated output devices to create the illusion of being inside the computer generated virtual reality world. For example, a head mounted display with a high resolution two dimensional color monitor in front of each eye can be used along with advanced three dimensional display techniques to create the illusion to the user that the user is inside the computer generated display. Alternatively, a high resolution color display, such as the NEC brand 20 inch monitor could be used to “immerse” the user into the virtual reality world.

The second feature of virtual reality is the ability of the user to navigate through the virtual reality world. For example, the virtual reality generator could create a computer module of a molecule or a city and enable the user to move through the molecule or city. In this case, the physical features of an exchange will comprise the virtual reality world. The user can navigate through the virtual reality world using control devices, such as a trackball or spaceball, an electronic dataglove, a magnetic head position tracker, a keyboard, a joystick or a steering wheel. The use of a magnetic head position tracker and dataglove creates a high feeling of immersion and grants the user the power to navigate (for example, by gestures) through the virtual reality environment.

The third feature of virtual reality, interaction, is the ability of the user to interact with and control the virtual reality world For example, a user can specify the parameters that define and metaphors that comprise the virtual reality world. Navigation and interaction are closely related concepts, though interaction extends to exchanges of information with others in the virtual reality world.

Virtual reality environments can be created using object-oriented libraries of functions. These functions can be inserted into a computer program for rapid prototyping to easily complete application development. A well known example of an object-oriented library of function is that created by the Sense Corporation of Sausalito, Calif., called the WorldToolKit library.

The WorldToolKit library of C routines lets a developer rapidly and easily build real-time three dimensional simulations and virtual world applications that run on desktop computers. The WorldToolKit library integrates a simulation manager, a real-time rendering pipeline, an object manager, texturing functions, animation sequences, input sensors, lights and graphics display devices in a flexible object-oriented library. The WorldToolKit library's texturing functions enable the development of applications with real-time texture mapping. Video-realistic textures can be applied to object surfaces in any orientation and scale, enabling the creation of compelling and lifelike virtual reality worlds. The WorldToolKit library has drivers for many popular control devices and output devices so that the user can configure input and output. Head-tracking, gesture tracking and object manipulation are accomplished by coupling sensors to graphical objects (or metaphors) and viewpoints. The WorldToolKit library is fully described in the WorldToolKit Reference Manual, 1991, published by the Sense8 Corporation, Sausalito. Of course, other similar systems can be used with the present invention.

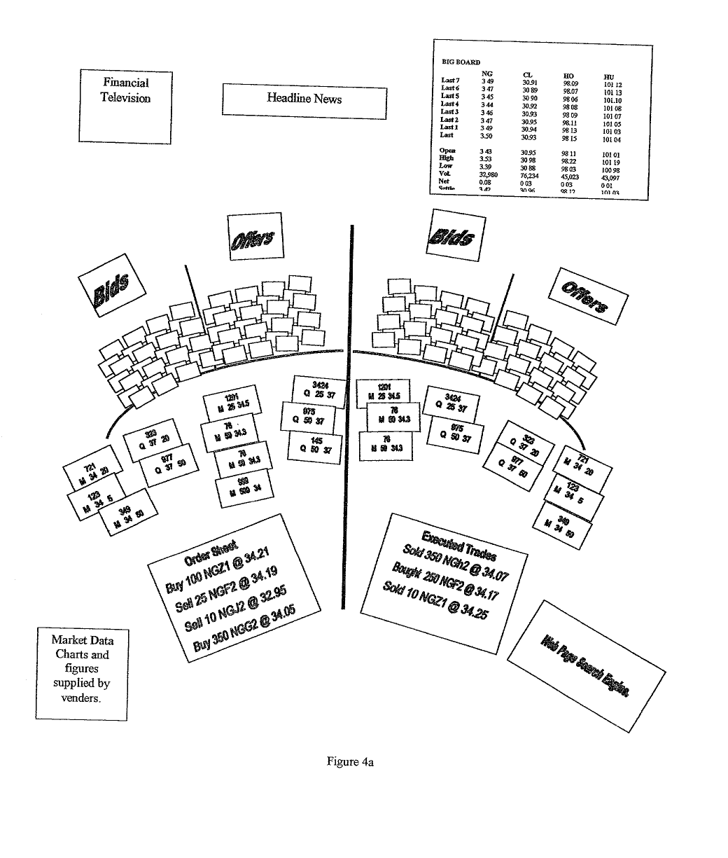

The electronic system consists of a three dimensional digital graphics and audio platform. As shown in FIGS. 4 and 4a, a virtual exchange environment 1 has traders 2 who congregate in a virtual exchange ring 3 to make markets using the open outcry auction methodology. As in an actual ring, this virtual ring has virtual steps where traders may congregate, though no one can occupy the same space at the same time. All bids and offers are recited in the same manner as is done on a physical exchange floor pit with one exception, market participants do not need to shout their bids and offers. Traders are able to see and hear each other in a virtual form in meetings and off the floor. During trading hours, each trader's body is an iconic representation which can be in the form of an avatar that will display his/her badge number/floor name 5 and their position 6. The position includes whether it is a bid or an offer, quantity, contract month, and the bid/offer price. In order to shorten the order display, bids and offers may be color-coded. Initially, the virtual body of a trader may be a computer depiction or a box, though ultimately animated or video avatars will likely be used, to more closely simulate the “real” world environment in the virtual reality setting.

In accordance with the invention, a trader or a broker announces the position 6 (i.e. Bid for 10 July or Offer 8 Jan at 21). The system verifies the order by presenting it in the order sheet 7 displayed in close proximity of the trader. If the broker feels the order is erroneous then he/she can motion the order to be canceled. When a trader 2a wishes to take the bid or offer of another trader he/she extends his virtual arm 8 to touch the counter party. The same and similar bids and offers are stacked above and next to each other in display 9. This enhances the speed of trading by allowing a trader to touch several bids/offers simultaneously. The system then matches the buyers' positions against the sellers'. If there is residual position left in the order sheet, the system displays the remainder. An optional zoom may allow zooming into a particular area in order to see the best bid or offer for closer inspection. A broker receives the clients' orders on the same order sheet 7 as well. The orders are executed in the same manner as a trader's own position. This insures true anonymity of clients without the possibility of a client's position being exposed to others, as may occur currently through open outcry.

One advantage over the actual trading floor is that these interactions are simultaneously recorded to provide a complete audit trail during the process. This substantially reduces the possibility for errors and even if made, eases their correction.

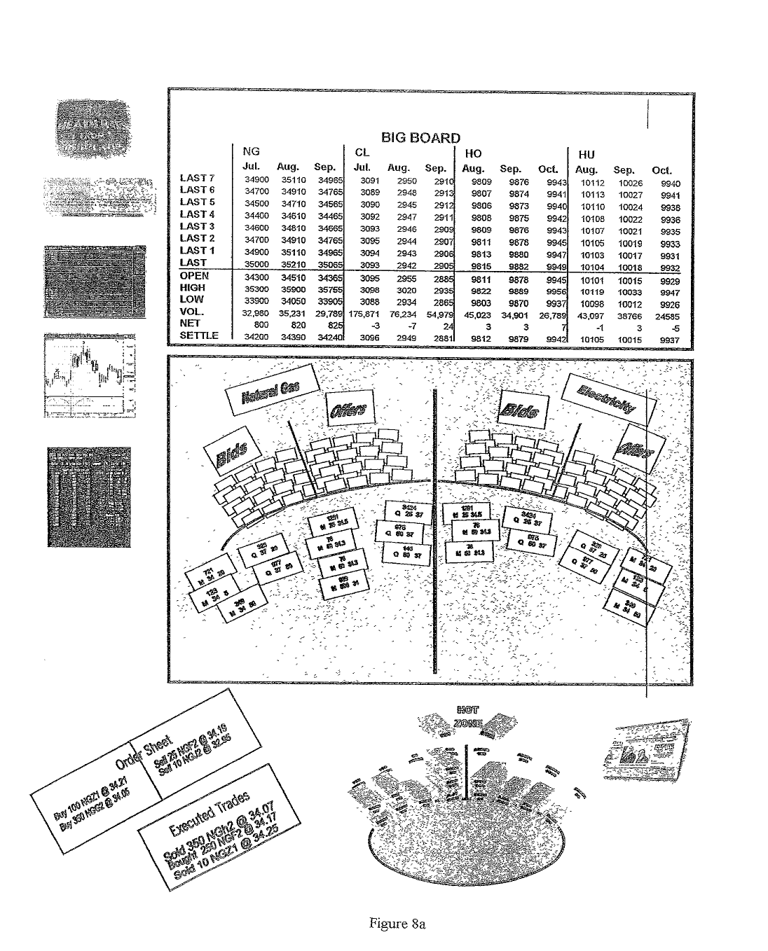

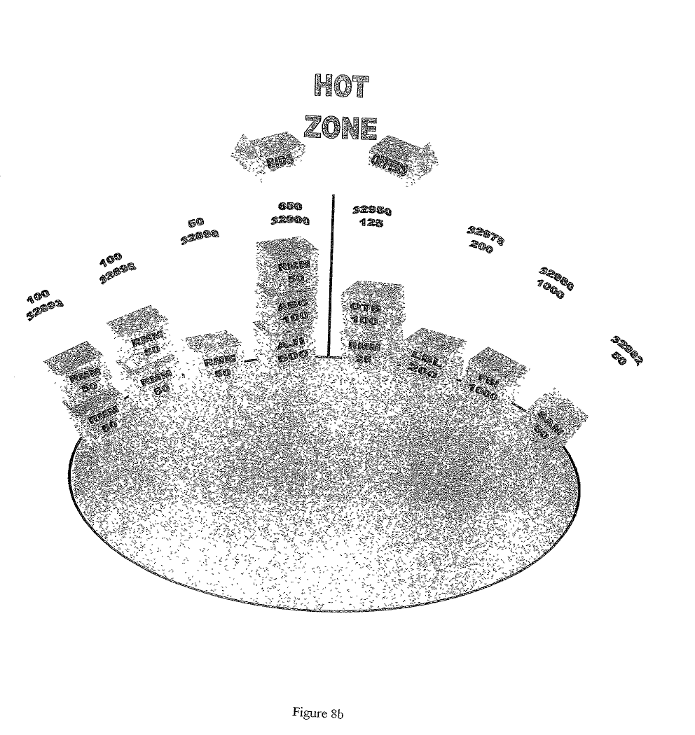

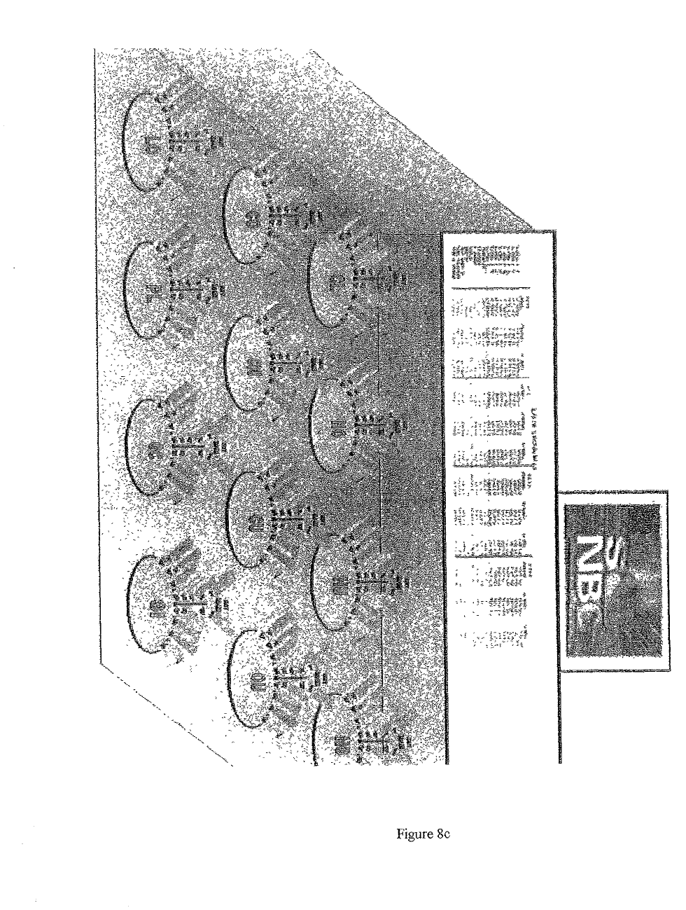

If a trader wishes to leave the pit to go to another market, he/she touches the selected market on the big board display 10 and then enters the pit or stands outside the trading ring to view the market activity. The floor participants have the ability to move the big board or a section of it to any part of the floor environment for better viewing. The big board preferably is a page or a window displaying the high, low, and last five trades. These pages resemble screen windows inside the virtual environment. Pages, screens, menus, and other internal displays can be moved around by the user to meet personal preferences, as shown in FIG. 8a.

For security, in one embodiment, the voice and/or retina of the members may be used for identification. This eliminates all unauthorized individuals from entering the exchange floor. A constant random check using a retina and/or voice identification systems ensures that the trader is a legitimate member of the exchange.

A broker 11 has a display containing all orders coming from an upstairs broker or an assistant via a slaved screen system 12 that may utilize a keyboard and mouse. A client 13 places an order with the upstairs broker. The broker 11 enters the trade into the slave system 12. The order appears in the order sheet 7 inside the floor brokers environment. Upon execution of the order the system automatically updates the order sheet display and the slave screen. This allows the upstairs broker to report the order fill to the client. Currently, future commission merchants (FCM's) enter orders either through a screen, which then are routed to the exchange floor or they are announced over the phone to a floor clerk. In either case the clerk then runs the orders to the floor broker in the pit and upon execution of the orders, the clerk then confirms the trades to the upstairs broker.

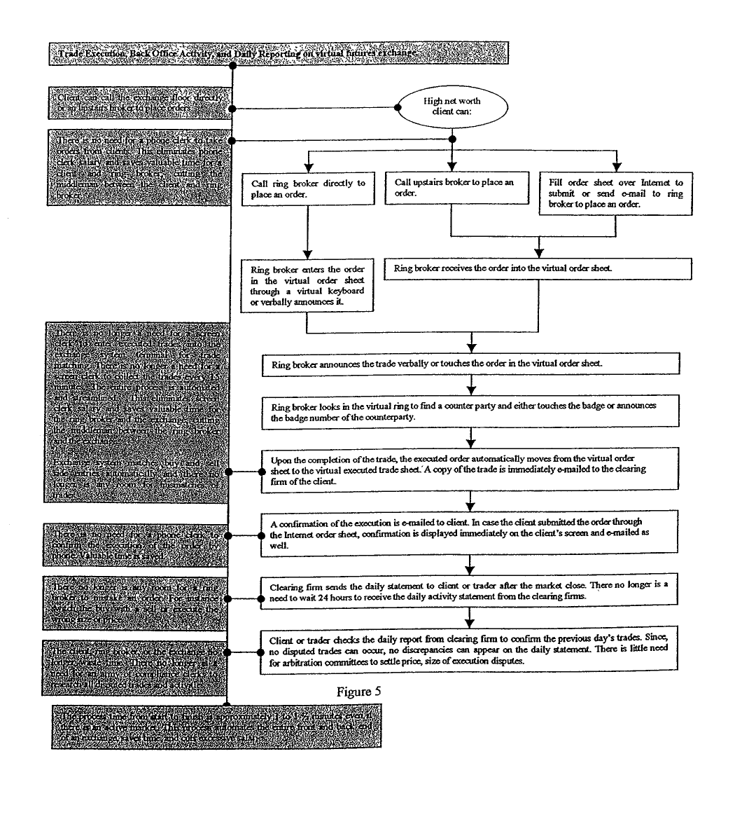

Referring to FIG. 5, this illustrates the trade execution, back office activity and trade reporting using the virtual exchange. This system eliminates the clerk and the associated expenses by allowing the upstairs broker to communicate directly with the floor broker. It also shortens the execution time dramatically, allowing for greater market efficiency.

The floor traders announce their bids and offers in an open outcry method without the need to raise their voices. When a bid and offer are matched a trade has taken place. The system then reports the trades to the FCM's and the clearing firms of the buyer and the seller.

### Arbitrage Opportunities

In the inventive system, arbitragers have the opportunity to hear the bids and offers first hand from the broker or an employee of a broker very much the same way as is done on the exchange floors. An upstairs broker has the opportunity to view the bids/offers in the pit. He/she then reports them to the client. Upon the clients request the upstairs broker recites the order to be entered into the executing brokers order sheet display. The upstairs brokers uses the same equipment as the broker though without the ability to place orders directly into the pit. The orders are entered into the broker's sheet. This is the only time that a broker will require assistance from a clerk, since this is the only function dependent on the level of specialized trades rather than the ease of use.

### Ouotes, Charts, and News Screens

As an additional option, a full quote system may be provided in the trader's virtual environment. The market participants would then have the opportunity to view historical prices, charts, derived data, and news on a page movable to any location in the members' environment. Traders will preferably have the ability to perform, using integrated software, a technical analysis of the charts provided, for example using a drop down menu of functions..

### Compliance Program Under the Commodity Exchange Act as Amended and Regulations Thereunder

As directed by the United States Congress, the Commodity Futures Trading Commission (“Commission”) is to facilitate the development and operation of computerized trading as an adjunct to the open outcry auction system. [Section 12(g)] As part of this, each contract market “shall maintain and utilize a system to monitor trading to detect violations of the contract market's rules and regulations.” The inventive system can readily comply with this by including: a method to observe trading, an integral audit trail and record keeping system, and an ability to review data on trades to detect violations and bring disciplinary actions against violators. [Section 5a(b)]

Furthermore, each contract market is required to comply with the following regulations:

(a) Reg. 1.50—Demonstration of continued compliance with the requirements for contract market designation. (This regulation is to show that the exchange is complying with the conditions and requirements of Sections 5 and 5a(a).

(b) Reg. 1.5 1—Contract market program for enforcement. (This is to show that the exchange has an affirmative program and has ongoing compliance with Sections 5, 5a(a), 5b, 6(b), 8a(7), 8a(9), and with regulation's relating to 4c(c).)

(c) Reg. 1.52—Self-regulatory organization adoption and surveillance of minimum financial requirements.

(d) Reg. 1.53—Enforcement of contract market bylaws, rules, regulations, and resolutions.

To comply with the Commission's requirements, an oversight Department may be integrated with the inventive system, possibly having three sections that are responsible for reviewing financial surveillance, market surveillance, and trade surveillance requirements under contract market rules and Commission regulations. Each section will develop methods and procedures to comply with exchange rules and with the Commission's requirements under the Commodity Exchange Act.

### 3D Visualization Architecture

The virtual system architecture may be provided by, for example, the 3D visualization software system for the creation of the PROMETHEUS^{SM} Exchange platform. Other virtual reality generators may also be used. For example, U.S. Pat. No. 6,020,885 describes a system for sharing a three-dimensional virtual reality space and such systems are known in the art primarily related to interactive gaming. These can be adapted for use in the present invention, though other systems could also be used.

The system will preferably operate via servers. The servers will preferably send packets of information via high band Internet-2 with a satellite communication network and a cellular system backup. The peripherals can be desktop PC's, laptops, VR gear and any other unit that conforms to the specifications for receiving data. Preferably, the basic overall virtual exchange environment generation will occur locally, to distribute this component of the system. Then, only interaction and update information need be transmitted, substantially increasing the speed at which such interactions are displayed. To maintain the currency of the basic exchange environment, periodic updates are included with the packets of information, transmitting only necessary changes. For example, the basic exchange environment can be updated every 20 minutes as opposed to the immediate transmissions necessary to simulate real time trading.

This can be accomplished by having distributed local servers that maintain the basic virtual exchange environment as well as facilitating interactive communication between servers. This is preferably managed by a host system, to assure that all traders view the same environment at substantially the same time. With such a system, interactions can be undertaken between users having relatively small computing devices that have virtual reality capability, and means for linking to the relevant local server. This will enable the system to be pervasive, with no need for a member to be physically located at a specific location, as well as providing the opportunity to conduct trades 24/7, without overwhelming a back office system. Full integration and immediate record monitoring can convert trading from a batch type system, to a continuous system, efficiently and without losing the character of a true securities exchange.

The system architecture for the virtual exchange has four main components. The user interface elements, the software architecture, the hardware architecture, and network architecture.

The architecture is based on the following high-level requirements:

Provide a virtual environment in which traders, located in remote locations, can participate on an open outcry trading floor;

Provide an interface to order execution systems;

Provide a virtual environment in which traders can feel comfortable;

Provide all trading data within the virtual environment in a manner which will be conspicuous and rapidly accessible;

Provide 100% uptime 24×7;

Provide the ability to quickly and effectively bring new users “on-line”;

Provide the ability to quickly and effectively bring new products “on-line.”

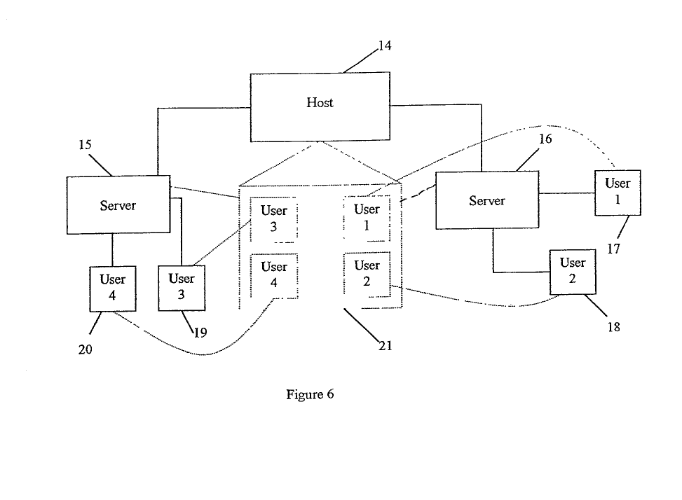

Referring to FIG. 6, a host computing system 14 is in communication with a pair of servers 15 and 16. Each server has two users 17, 18, 19, 20. (Of course, the small number eases the illustration and scale up to many more users and servers would be understood based on this example.) The host system and servers provide access to a virtual trading environment 21. The users do not interact with the computers, but with each other in the virtual exchange environment, with the users immersed in an environment illustrated by the displays as shown in FIGS. 8a-8c.

### User Interface Elements

The User Interface Elements (UIE) constitute the equipment used as an interface to access the virtual exchange. The UIE receives end-users input and transmit that input to the system.

The UIE consists primarily of vision, user input, and audio transmission. The vision element enables the user to view the virtual world and be a participant within it. The user input element enables users to act within the system by either moving or making selections within the virtual world. The audio component will provide for high-fidelity acoustics within the virtual environment. One such system is described in U.S. Pat. No. 6,041,127, which uses a microphone array that is steerable for use in virtual reality audio applications. Of course, other systems could be used.

Again, there are existing systems for optical, mechanical, audio or video input, interaction with the virtual reality space and these existing systems are readily adaptable for use in the present inventions. (See also U.S. Pat. Nos. 6,049,327 relative to hand gesture; 5,844,674 for optical position sensing; 6,052,114 for body sensing; and, 6,050,822 for total immersion systems.)

A variety of UWE approaches exist. One such approach is the head-mounted displays (HMDs) for vision, electronic gloves for manual input and 3D sound speakers directly mounted on the HMD equipment. This type of framework enables the user to have flexibility and freedom to move. However, the products must be lightweight enough to permit the user to carry the gear for long periods of time.

Another approach is to use a virtual dome. A number of systems enable a user to enter a self-contained area called a dome, which provides for an enclosed virtual environment. Various input devices such as the glove can be used in this type of environment. Another approach may be to utilize video blue screen technologies to display images of participants in the virtual world, circumventing the need to invent object agents, or visual avatars.

### Software Architecture

The software architecture has three main elements. The first component is the user interface component. This interface gathers input from the user and displays the virtual world to the user. The user interface component interacts with the trading floor component to obtain information from the trading floor, and the database and execution interface. The user interface component contains most of the virtual objects that model the environment.

The second component—trading floor constituents (server-based components) gathers the input data from users, updates the database and execution mesh component, and constantly or periodically refreshes the trading floor, as described previously. The trading floor component may consist of application servers. Transaction monitoring software tracks all trades and identifies transaction times, manages security, handles load processing and other activities.

The third component—the database and execution interface component stores persistent data and transmits the data to the trade execution systems. This component may transact only with the trading floor component, as it will only need trading data, but of course, this can be supplemented to assure adequate recording and monitoring.

### Hardware Architecture

The hardware architecture, discussed previously with reference to FIG. 6, preferably consists of servers at distributed data centers. The severs are connected using high-bandwidth data connections and clustering software. The architecture supports a plug-n-play framework enabling servers to be added and removed based on load factors. Load balancing software manages the distribution of processing among servers. Currently, British Telecommunications has a working commercialized product which may be usable with the present invention, though other systems can be used.

### Network Architecture

The networking architecture provides for rapid connectivity between servers in the data centers and end-user traders at the remote sites. The most effective networking architecture is that of a virtual private network (VPN). This would utilize the worldwide Internet infrastructure but utilize private channels, connecting all remote sites to the data centers. The VPN could be hosted by a particular network provider or by a variety of such providers, based on the geographic location of the traders.

### The Structure of the Virtual Exchanges

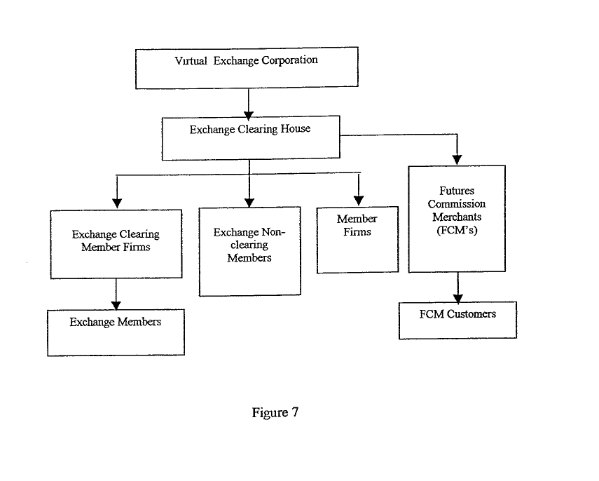

A basic structure of a typical U.S. exchange is provided as a virtual futures exchange as illustrated in FIG. 7. Although there are variations to this structure, the explanations and the illustration are the most basic fundamental rules of how an exchange is structured, and these are mirrored in the virtual environment.

### The Virtual (Futures and Securities) Exchange Clearing House

The virtual futures exchange may initially rely on the International Commodities Clearing House (ICCH) to clear the futures contracts. The virtual stock exchange may initially rely on the National Securities Clearing Corporation and International Securities Clearing Corporation to clear the securities. Of course, the virtual exchange may utilize its own clearinghouse. The nature of a clearinghouse is like an exchange corporation. A clearinghouse is typically a for profit or non-profit organization. The basic function of a clearinghouse is to clear futures contracts, options, or securities. This entails recording of overnight positions handed down from the clearing members. At this point the clearinghouse assumes certain responsibilities for the performance of the buy and sell side. In so doing the clearinghouse requires its members to maintain a margin account with the clearinghouse as a collateral against default based on a formatted structure. The clearinghouse also monitors the financial integrity of its members, sometimes requiring corrective action. Finally, the clearinghouse maintains a guarantee fund to cover defaults. By these measures—record keeping, margin requirements, financial oversight of members, and a guarantee fund—a clearinghouse supports the financial integrity of a futures, options, or securities market. Although most U.S. futures and securities exchanges have their own clearing operations, the clearing operations of several different exchanges can be consolidated within a single clearing corporation. The International Commodities Clearing House (ICCH), for example clears for most of the futures exchanges internationally and National Securities Clearing Corporation and International Securities Clearing Corporation clear almost all the securities exchanges globally.

### The Virtual Exchange Clearing Member Firms

All futures contracts must be cleared. The virtual futures and stock exchange members that are not clearing members will have to maintain an account with a virtual exchange clearing member for this purpose. Exchange members have the option of becoming a clearing member by purchasing equity in the virtual exchange clearinghouse. This avoids clearing through other members and the associated fees and margin requirements.

### The Virtual Exchange Members and Member Firms

The essence of a futures or stock market is its exchange members—in case of the virtual exchange, it is the equity holders who have the trading rights. Membership or trading rights will be limited to individuals. These individual members will act on behalf of firms such as brokerage houses, investment banks, or commodity/security dealers and producers. At some exchanges firms may not be required to have an individual to maintain membership. Instead, the firm becomes the member of the exchange. Firms will not be able to have trading rights at the virtual exchange. No firm should become a majority owner of the virtual exchange. The total number of trading rights of the virtual exchange is preferably limited. Memberships or trading rights may themselves be available for sale on the electronic floor of the virtual exchange. The value of membership or trading right will lie mainly in the privileges it conveys for trading contracts directly on the 3-D electronic floor of a virtual exchange, with immediacy and low transaction fees. These members, nominees of members, and other individuals who actually have and use floor-trading privileges will be traders. Several basic categories of traders serve to distinguish their reasons for trade, and often distinguish as well a particular variety of trading privileges and special transaction fees. These classifications will be: (1) Floor Brokers, who typically execute orders placed with them from off the floor of the exchange or by other traders; (2) Day Traders, who trade for their own accounts and offset their contract positions each day before the end of trading; (3) Opportunity traders, who trade for their own accounts, and specialize in contract positions held over short intervals of time; (4) Position Traders, who trade on their own accounts and may hold contracts over a period of days or weeks.

Although floor brokers sometimes trade their own accounts, their basic role is the chain of transaction services allowing the public at large to buy or sell contracts. Floor brokers profit mainly from fees for this service. Traders on other classifications attempt to profit from price movements, either by small price advantages that may appear for very short periods of time, or via some understanding of the general formation of spot, futures, or securities market prices combined with the information continually coming onto the electronic floor of the exchange. Collectively, they meet a critical need for liquidity, the ability of the market to act as a reliable and efficient mechanism for quickly taking or offsetting contract or security positions.

### Future Commission Merchants (FCM'S) and Brokerage Firms

A Futures Commission Merchant is an intermediary between its customers, drawn from the public at large, and the floor brokers, of a futures exchange. A broker/dealer provides the same function on the securities exchange. An FCM acts as an agent for customers, placing orders and maintaining accounts. The FCM'S and broker/dealers are able to route the customers orders to the virtual floor broker via a slave screen that is tied into the brokers order sheet screen in the virtual environment.

### Customers

Large customers, such as producers, commodity merchants, exporters, investment banks, and funds may bypass FCM'S by purchasing an exchange membership allowing them to place positions directly on the floor of an exchange, with corresponding immediacy and lower transaction costs. In many cases, such members may place orders with independent virtual floor brokers in order to disguise the source and the size of the trade. These customers have the option of routing orders to several virtual exchange independent brokers via slave screens placed on their premises.

### The Virtual Exchange Operations and Trading Procedures

The operations center of the virtual exchanges will require one to two employees at any given time or trading period. The 3-D visualization and gliding software will enable operations personnel to glide to the source of trouble and determine a means of action. A compliance officer can glide to a hot zone (see FIG. 8) and take proper actions against traders who violate exchange rules.

### Price Limits

The virtual futures exchange, subject to the approval of the CFTC, sets limits at the end of each trading session on the prices of certain futures market at which trades may occur on the following trading day or period. Trading outside of these price limits is prohibited, with the obvious potential for an excess supply of a contract at its lower price limit or an excess demand at its upper limit. Price limits provide a measure of financial integrity at times of extreme fluctuations in certain market conditions. For some markets, the virtual futures exchange may also have variable price limits, allowing price limits during a given trading session to expand according to formulas. Some contracts may not have price limits at all. This process is dependent on the underlying markets.

### The Opening Call and the Close

Trading will begin on the electronic 3-D floor of the exchange each day or period with an opening call for each contract. The opening call establishes an opening price or opening range for prices by posting traders' initial bids and offers as well as the actual prices and quantities traded. After traders have the opportunity to execute trades at the opening call, the continuous open outcry auction begins. For certain markets, a separate opening call is held in each electronic pit for each delivery date in succession before the beginning of continuous trading by open outcry. The opening call is intended to allow an orderly start of trading and filling of orders that require execution in the opening range. A closing range is similarly established in the range of prices at ED4l the end of the trading period for a given contract. A trader filling a large order at the close has the opportunity to request that the closing range include all prices of transactions occurring while that order is filled.

### The Settlement Prices

The settlement price is a representative price from the closing range, generally as close as possible to the midpoint of the closing range. The settlement price, similar in concept to the closing price on the virtual stock exchange, is used to determine margin requirements and price limits. A special settlement committee for each futures market is given the responsibility to choose settlement prices electronically. The opening and closing of trade in a given contract is signaled with a bell; trading is forbidden before the opening bell or after the closing bell. Daily trading hours may vary by contract.

### Reporting Prices and Other Information

The immediate availability of market information to traders and customers is an important requirement for a successful futures exchange. Since all trades, bids and offers are captured electronically, the virtual exchange is able to widely disseminate the ticker for a fee.

### Pit Reporting

There is no longer a need for reporters (employees of an exchange) at the virtual exchanges. Usually, reporters are located at the rostrums or pulpits adjacent to each pit on a physical floor of an exchange, and record the times and prices of bids and offers. The reporting process is automatic. Since each trade is recorded electronically, they are widely disseminated off the trading floor by ticker tape and directly to electronic market quotation services. At the virtual exchanges, prices are electronically recorded and displayed on a large board above the electronic trading floor in the virtual space of the trader. Customers thus have a faster display of prices.

### Facilities at the Virtual Exchanges

The most important commodity on the floor of any exchange is time. For this reason the exchanges provide market information via electronic wallboards, charting, news, and quote systems, and internal time and sales screens. Even with the information available to traders, time is wasted when they have to move from the trading pits to view charts, quotes, and news on a quote screen situated at a different part of the exchange floor. At the virtual exchanges, information screen displaying user selected charts, quotes, and news are situated inside the field of view of a traders' virtual environment.

Even though the electronic wall board is at a fixed location on the floor of the exchanges for everyone's viewing, not all traders have the field of view of the big board. Depending on where a trader is situated in a pit on the floor of an exchange, the wallboard may be situated behind him out of his/her sight. The wallboard inside the virtual exchange floor is in the field of view of the trader (see FIG. 8), and there is no time wasted on the virtual exchange floor.

### Electronic Wallboard Display

As discussed previously, and with reference to FIG. 8, an image box resembling an electronic board displays price, volume and open interest data within view of a trader in the electronic pit. For each contract type, by delivery date, the board preferably shows, from top to bottom: 1) the opening range, 2) the high for the day, 3) the low for the day, 4) estimated volume, 5) the most recent seven prices recorded before the last recorded price, 6) the last recorded price, 7) net change, 8) settle, 9) year high, 10) year low.

On a physical floor of an existing exchange, a member of the pit or floor committee may have to call a fast market in a situation of unusually heavy trading activity. During a fast market, it is understood that the information collected or displayed on the board may not be complete or accurate. At these times, only the last four (rather than seven) prices are shown. On the electronic floor of virtual exchanges, there is no need for a floor committee to call a fast market since all trades are automatically and electronically recorded, displayed, and widely disseminated.

### Computerized Time and Sales Inquiry

Throughout the larger futures exchanges, terminals dispense information on trades sorted by time and price according to the user's request. Time and sales are at the disposal of traders inside their virtual environment, through their customizable information display.

### Video Monitors

Located throughout the trading floor of large modern exchanges are video monitors showing different selections of information such as market charts, news from various vendors, and price tables from the ticker and the electronic wallboard display. These monitors are intended to feed the traders' needs for current information on conditions in related markets. As shown in FIG. 8, at the virtual exchanges, the video monitor is displayed inside the virtual environment of the trader.

### Orders on the Virtual Exchange Floors

A futures order is an instruction by a customer of a futures commodity merchant (FCM) to a representative of the FCM to buy or sell futures contracts and securities. All orders are routed via slave screens from the FCM sites to the brokers' virtual environment.

### Order Ticket Information and Placement

A request to buy or sell a given number of a particular futures contract or number of shares at the best or limit price will be available via slave screens that are routed to a page inside the brokers virtual environment. The representative of the FCM is no longer be required to place information on the multipart order form as is done for other exchanges. The registered representative selects and enters the following information into the slave screen which is routed to the virtual page of the broker:

1. The action code, such as buy (BUY), sell (SL), cancel (CXL), or cancel a former order (CFO), which generally means to cancel only some part of a former order (as opposed to CXL for a complete order cancellation).

2. The quantity, an integer number of contracts (or, for certain contract types, a number of units, such as “1000 MMBTU's” of natural gas).

3. The contract description, stating both contract type and delivery date by month, such as “December (Z) natural gas.”

4. The futures or swap price, or in the case of a market order, “MKT,” to indicate “at the market,” meaning at the best available price.

5. The execution instructions such as limit, market-if-touched (MIT), stop limit.

6. The order duration, the period of time during which the order may be filled.

7. The customer's account number.

8. The initials of, or some other code for, the AP of the FCM.

### Handling of the Orders

Orders are generally handled in the following sequence on the virtual exchange floors:

1. The customer will communicate the order, perhaps by telephone, to the FCM. In some cases, high net worth individuals and fund managers may call directly to the broker on the floor of the virtual exchange or they will have a slave screen from which they will enter their orders.

2. A registered representative enters the order information into the slave screen containing the information listed above. The screen based order ticket automatically is time stamped as soon as the registered representative presses the send key. An FCM that is not a member of the virtual exchange comes to an arrangement with a member of the exchange.

3. The floor broker views and reviews the batch orders to be filled inside the order page and he/she takes the appropriate trading action.

4. At execution, the floor broker confirms the execution of the order by virtually touching the order inside the order page. At the time of execution the virtual exchange electronically records the trade and places it inside the order page. The recorded information is the price, the quantity (if a partial execution), and the broker or trader on the opposite side of the trade. The information is then automatically relayed back to the slave screen at the FCM desk.

Notice that a few steps that have been eliminated are a floor representative of the FCM placing the order information on an order form, time stamping the order form, and relaying the order, often by floor messenger, to a floor broker trading for the FCM in the appropriate pit or an FCM order desk. The registered representative and the floor broker no longer has a go-between, the order desk. Another step that is removed is the function of an assigned FCM employee or a clerk at the edge of the pit placing orders into his or her order deck. Removing these layers will save time and employee costs.

The floor broker no longer spends time recording on the order form price, quantity, and the opposite broker and then relaying the order form back to the FCM desk. These are time consuming steps. The entire sequence above is a fraction of a few seconds. Meanwhile, on a physical exchange, this can take as much as two to three minutes and even longer to complete.

### Elimination of Errors on the Virtual Exchange

Exchanges typically promote the idea that despite often hectic conditions and high transactions volumes, errors are uncommon, but the fact of the matter is that errors happen on a daily basis and the average error may be $10,000 or more. These errors occur even at times when the market is quiet and little activity is shown on the floor of the exchange. For instance, a clerk who was supposed to give a client's sell market on close order (MOC) to a broker to cover an open long position. Instead, forgot about the order, placed it in his pocket and after the market closed for the day he left the exchange. The next day the market opened sharply lower and he realized that he forgot to execute the order. This can be a costly error for all parties involved.

At the virtual exchange, these errors are eliminated since all orders and open positions are displayed in the order and execution pages of the broker/trader. And since one layer of personnel, the clerk, is removed from the trading process, all trades have to be executed.

Another type of error eliminated are discrepancies between the buying and selling traders' execution. At a physical exchange the buyer and seller execution records are handled by the out order procedure at the clearing stage, one day later. Errors in handling an order (failure to execute a market order near the best available price at the time the order is stamped) are corrected if necessary by an exchange regulated procedure the day after the trade occurs. At the virtual exchange, all trades have to be agreed upon before consummation of the trade.

In summary, the present invention utilizes a computer based virtual reality trading system comprising:

means for storing a substantially visually accurate image of a trading floor;

means for storing a plurality of visual images, each of which corresponds to a visually accurate representation of multiple traders; and

means for generating an interactive virtual trading floor space and for generating virtual images of the multiple traders thereon and for supporting interactive trading between the multiple users; and means for multiple traders to interact via their virtual multiple trader persons on the virtual trading floor.

The system above can further comprise means for recording and storing the interactive trades on computer media.

The system above can further comprise means for supplying selected information viewable by a virtual trader while in the virtual trading environment.

The virtual exchange can further comprise means for enabling a trader to control his/her virtual trader persona via signals selected from the group consisting of voice, optical, mechanical, hand, body or head movement.

The virtual exchange can further include means for clearing trades.

The virtual exchange can comprise at least one server for generating the virtual trading floor, multiple traders networked to and in communication with the server for interacting with other traders via voice recognition and/or hand signals so as to simulate a virtual open out call auction system for the products traded.

A method of the invention comprises providing a method for trading products in a virtual reality environment by providing a virtual reality generator producing 3-dimensional images of a trading floor;

providing an avatar within the virtual reality trading floor corresponding to each trader;

providing control signals from the trader to the avitar to direct the avitar in the virtual reality trading floor;

observing other traders in the virtual reality trading floor; and

interacting the avatars of multiple traders to simulate an open out call auction and completing trades on the virtual trading floor.

While preferred embodiments of the present invention have been shown and described, it will be understood that various changes or modifications could be made without varying from the scope of the invention.

What is claimed is:

1. A computer based virtual reality trading system for trading financial products comprising:
means for storing a substantially visually accurate image of a trading floor;
means for storing a plurality of visual images, each of which corresponds to a visually accurate representation of one of a plurality of traders; and
means for generating an interactive virtual trading floor space and for generating virtual trader persons corresponding to the virtual images of the plurality of traders therein and for supporting interactive trading between a plurality of the virtual trader persons; and,
means for the plurality of traders to interact and complete trades via their virtual trader persons on the virtual trading floor.

2. The system according to claim 1 further comprising means for recording and storing the interactive trades on computer media.

3. The system according to claim 1 further comprising means for supplying selected information to the plurality of traders while in the virtual trading floor space.

4. The system according to claim 1 further comprising means for enabling a trader to control a corresponding virtual trader persona via signals selected from the group consisting of voice, optical, mechanical, hand, body or head movement.

5. The system according to claim 1 further comprising means for clearing trades.

6. The system according to claim 1 further comprising at least one server for generating the virtual trading floor, the plurality of traders networked to and in communication with the server for interaction via voice recognition and/or hand signals so as to simulate a virtual open out call auction system.

7. A method for trading financial products in a virtual reality environment comprising:
providing a virtual reality generator for producing 3-dimensional images of a trading floor to generate a virtual reality trading floor;
providing a plurality of avatars within the virtual reality trading floor corresponding to a plurality of traders;
providing control signals from a trader to a corresponding avatar to direct the corresponding avatar on the virtual reality trading floor;
observing other traders via their corresponding avatars on the virtual reality trading floor;
interacting the avatars of the plurality of traders to simulate an open out call auction; and
completing trades on the virtual trading floor.

8. The method of claim 7 further comprising recording and storing the interactive trades on computer media.

9. The method according to claim 7 further comprising supplying selected information to the plurality of traders while on the virtual trading floor.

10. The method according to claim 7 further comprising enabling a trader to control a corresponding avatar via signals selected from the group consisting of voice, optical, mechanical, hand, body or head movement.

11. The method according to claim 7 further comprising clearing the completed trades.

12. The method according to claim 7 further comprising generating the virtual trading floor using at least one server, and, networking the plurality of traders with the server.

13. The method according to claim 7 wherein the interaction of the avatars is by voice recognition and hand signals so as to simulate a virtual open out call auction.

14. The method according to claim 7 further comprising providing processing means for coordinating responses on a common virtual time scale, to accommodate transmission delays.

15. The method according to claim 7 further comprising verifying the identity of each registered user on the trading floor.

16. The method according to claim 7 further comprising generating and transmitting a report of completed trades to a clearing firm.

17. The method according to claim 7 further comprising providing information selected from news, product price history, financial charts, and combinations thereof to each registered user.

18. The method according to claim 7 further comprising monitoring and recording trade activity and reviewing trade activity for rule violations.

19. The method according to claim 7 further comprising providing at least one server containing 3D visualization software for generating the virtual trading floor and for supporting virtual interactions among the avatars therein.

20. The method according to claim 7 further comprising providing multiple servers distributed at locations local to one or more of the plurality of traders, and coordinating the servers to maintain a common virtual trading floor.

21. The method according to claim 20 further comprising a host computer system for monitoring the multiple servers to assure that the plurality of traders view the same virtual trading floor and avatars at substantially the same time.

22. A computer trading system for trading financial products comprising:
means for creating a virtual environment simulating a trading floor;
means for providing multiuser registration for accessing the trading floor;
means for establishing an iconic representation for each registered user; means for supporting direct interaction between the iconic representation to effect trading interactions; and
means for recording and storing the trading interactions.

23. The computer trading system of claim 22 further comprising a plurality of computer terminals connected thereto for accessing the trading floor.

24. The computer trading system of claim 23 wherein at least one computer terminal has voice recognition software for repeating vocal statements on the trading floor.

25. The computer trading system of claim 22 wherein the computer trading system has processing means for coordinating responses on a common virtual time scale, to accommodate transmission delays.

26. The computer trading system of claim 22 further comprising means for verifying the identity of each registered users on the trading floor.

27. The computer trading system of claim 22 further comprising means to generate and transmit a report of completed trades to a clearing firm.

28. The computer trading system of claim 22 further comprising means to provide information selected from news, product price history, financial charts, and combinations thereof to each registered user.

29. The computer trading system of claim 22 further comprising oversight means to monitor trading and to review trade activity for rule violations.

30. The computer trading system of claim 22 wherein the system has at least one server containing 3D visualization software for generating the virtual trading floor and for supporting virtual interactions among registered users therein.

31. The computer trading system of claim 22 wherein the system has multiple servers distributed at locations local to one or more registered users, the servers coordinated to maintain the virtual environment.

32. The computer trading system of claim 22 further comprising a host computer system for monitoring the multiple servers to assure that all registered users view the same virtual environment at substantially the same time.
